(19) United States
(12) Patent Application Publication
(10) Pub. No.: US 2026/0249559 A1
(43) Pub. Date: Aug. 27, 2026

(54) METHOD FOR MANUFACTURING THREE-DIMENSIONAL SHAPED OBJECT

(71) Applicant: SEIKO EPSON CORPORATION, Tokyo (JP)

(72) Inventor: Hayato ASUKA, SHIOJIRI-SHI (JP)

(73) Assignee: SEIKO EPSON CORPORATION, Tokyo (JP)

(21) Appl. No.: 19/539,052

(22) Filed: Feb. 13, 2026

(30) Foreign Application Priority Data
Feb. 21, 2025 (JP) 2025-026535

(51) Int. Cl. B29C 64/40; B29C 64/106; B33Y 10/00; B29K 25/00; B29K 55/02

(52) U.S. Cl. CPC B29C 64/40; B29C 64/106; B33Y 10/00; B29K 2025/06; B29K 2055/02

(57) ABSTRACT

A method for manufacturing a three-dimensional shaped object includes: ejecting a first material to shape a release layer at a stage; ejecting a second material to stack a shaping layer at the release layer and shape a main body portion of the three-dimensional shaped object; and ejecting a third material to shape a brim layer at the release layer. The release layer and the brim layer are layers separated from the main body portion, and the brim layer has a triangular prismatic portion in contact with a corner portion of an outer shell of the main body portion in a plan view.

The present application is based on, and claims priority from JP Application Serial Number 2025-026535, filed February 21, 2025, the disclosure of which is hereby incorporated by reference herein in its entirety.

### BACKGROUND

### 1. Technical Field

The present disclosure relates to a method for manufacturing a three-dimensional shaped object.

### 2. Related Art

A method for manufacturing a three-dimensional shaped object by ejecting a plasticized material from a nozzle toward a stage and curing the material is known.

For example, JP-A-2019-72943 describes that occurrence of warpage in a three-dimensional object to be shaped is prevented by applying a circular brim coupled to an outer circumference in an optimized state in accordance with each layer.

JP-A-2019-72943 is an example of the related art.

As described above, there is a demand for a method for manufacturing a three-dimensional shaped object capable of reducing warpage of the three-dimensional shaped object.

### SUMMARY

An aspect of a method for manufacturing a three-dimensional shaped object according to the present disclosure includes:

ejecting a first material to shape a release layer at a stage;

ejecting a second material to stack a shaping layer at the release layer and shape a main body portion of the three-dimensional shaped object; and

ejecting a third material to shape a brim layer at the release layer, in which

the release layer and the brim layer are layers separated from the main body portion, and

the brim layer has a triangular prismatic portion in contact with a corner portion of an outer shell of the main body portion in a plan view.

### BRIEF DESCRIPTION OF THE DRAWINGS

FIG. 1 is a perspective view schematically showing a three-dimensional shaping device according to an embodiment.

FIG. 2 is a cross-sectional view schematically showing the three-dimensional shaping device according to the embodiment.

FIG. 3 is a perspective view schematically showing a screw of the three-dimensional shaping device according to the embodiment.

FIG. 4 is a diagram schematically showing a barrel of the three-dimensional shaping device according to the embodiment.

FIG. 5 is a perspective view schematically showing a three-dimensional shaped object according to the embodiment.

FIG. 6 is a plan view schematically showing the three-dimensional shaped object according to the embodiment.

FIG. 7 is a flowchart showing processing of a control unit of the three-dimensional shaping device according to the embodiment.

FIG. 8 is a cross-sectional view showing the processing of the control unit of the three-dimensional shaping device according to the embodiment.

FIG. 9 is a flowchart showing the processing of the control unit of the three-dimensional shaping device according to the embodiment.

FIG. 10 is a plan view schematically showing a three-dimensional shaped object according to a first modification of the embodiment.

FIG. 11 is a perspective view schematically showing a three-dimensional shaped object according to a second modification of the embodiment.

FIG. 12 is a perspective view schematically showing a three-dimensional shaped object according to a third modification of the embodiment.

FIG. 13 is a plan view schematically showing a columnar structure portion of a brim layer of a three-dimensional shaped object according to a reference example.

FIG. 14 is a perspective view schematically showing Sample 1 used in an experimental example.

FIG. 15 is a perspective view schematically showing Sample 2 used in the experimental example.

FIG. 16 is a perspective view schematically showing Sample 3 used in the experimental example.

FIG. 17 is a perspective view schematically showing Sample 4 used in the experimental example.

FIG. 18 is a perspective view schematically showing Sample 5 used in the experimental example.

FIG. 19 is a perspective view schematically showing Sample 6 used in the experimental example.

FIG. 20 is a perspective view schematically showing Sample 7 used in the experimental example.

FIG. 21 is a perspective view schematically showing Sample 8 used in the experimental example.

FIG. 22 is a perspective view schematically showing Sample 9 used in the experimental example.

FIG. 23 is a perspective view schematically showing Sample 10 used in the experimental example.

FIG. 24 is a perspective view schematically showing Sample 11 used in the experimental example.

FIG. 25 is a side view of a main body portion showing an evaluation method for warpage in the experimental example.

FIG. 26 is a table showing an evaluation result of the experimental example.

FIG. 27 is a graph showing the evaluation result of the experimental example.

### DESCRIPTION OF EMBODIMENTS

A preferable embodiment of the present disclosure will be described below in detail with reference to the drawings. The embodiment to be described below does not unduly limit the content of the present disclosure described in the claims. Further, not all configurations to be described below are necessary elements of the present disclosure.

### 1. Three-Dimensional Shaping Device

### 1.1. Overall Configuration

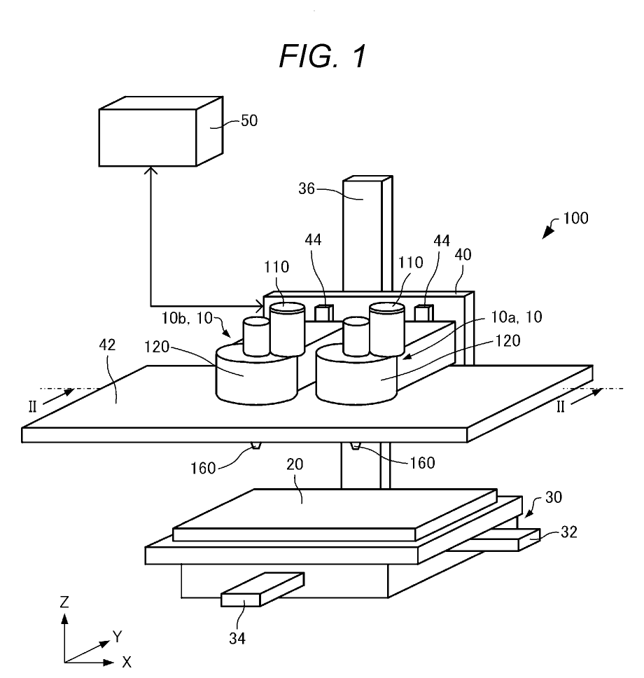

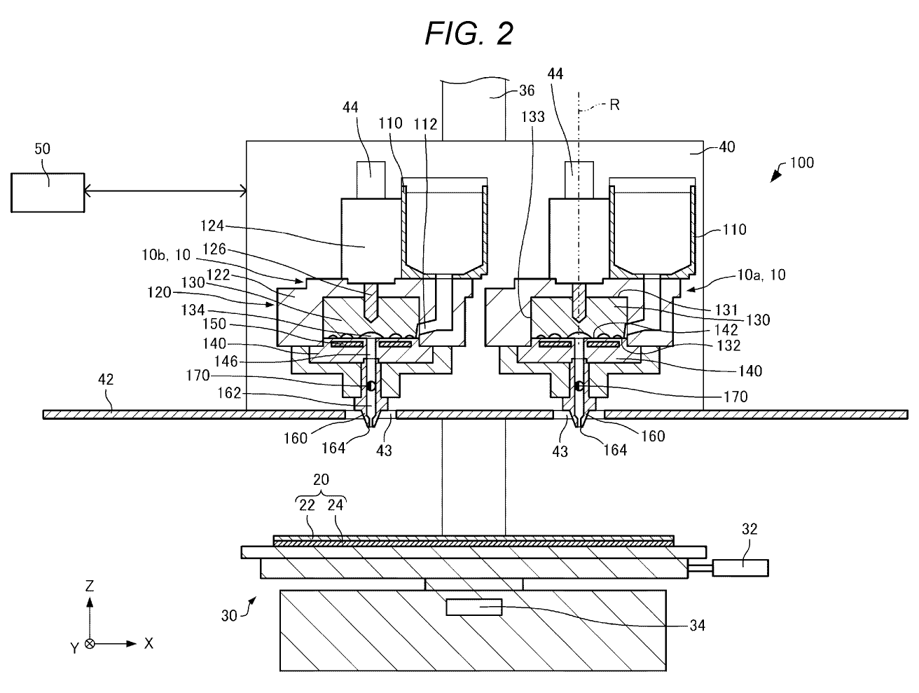

First, a three-dimensional shaping device according to the embodiment will be described with reference to the drawings. FIG. 1 is a perspective view schematically showing a three-dimensional shaping device 100 according to the embodiment. FIG. 2 is a cross-sectional view taken along a line II-II of FIG. 1 schematically showing the three-dimensional shaping device 100 according to the embodiment. In FIGS. 1 and 2, an X-axis, a Y-axis, and a Z-axis are shown as three axes orthogonal to one another. An X-axis direction and a Y-axis direction are, for example, horizontal directions. A Z-axis direction is, for example, a vertical direction.

As shown in FIGS. 1 and 2, the three-dimensional shaping device 100 includes, for example, ejecting units 10, a stage 20, a position change unit 30, a support unit 40, a heating plate 42, drive units 44, and a control unit 50.

While causing the ejecting unit 10 to eject a plasticized material toward the stage 20, the three-dimensional shaping device 100 drives the position change unit 30 to change relative positions of the ejecting unit 10 and the stage 20. Accordingly, the three-dimensional shaping device 100 manufactures a three-dimensional shaped object by stacking, at the stage 20, a shaping layer formed by the plasticized material. The three-dimensional shaping device 100 is a three-dimensional shaping device of a fused deposition modeling (FDM) type.

The three-dimensional shaping device 100 includes a first ejecting unit 10a and a second ejecting unit 10b as the ejecting units 10. In the shown example, the first ejecting unit 10a and the second ejecting unit 10b are arranged in the X-axis direction. The first ejecting unit 10a and the second ejecting unit 10b have the same configuration, for example. Although not shown, one of the first ejecting unit 10a and the second ejecting unit 10b may not be provided.

As shown in FIG. 2, the ejecting unit 10 includes, for example, a material supply unit 110, a plasticizing unit 120, a nozzle 160, and a valve 170.

The material supply unit 110 stores a pellet-like or powder-like material. The material supply unit 110 supplies the material to the plasticizing unit 120. The material supply unit 110 is implemented by, for example, a hopper. The material supplied from the material supply unit 110 of the first ejecting unit 10a is, for example, acrylonitrile butadiene styrene (ABS) resin. The material supplied from the material supply unit 110 of the second ejecting unit 10b is, for example, high-impact polystyrene (HIPS) in which rubber is blended with polystyrene (PS).

The material supply unit 110 and the plasticizing unit 120 are coupled by a supply path 112 provided below the material supply unit 110. The material supplied to the material supply unit 110 is supplied to the plasticizing unit 120 via the supply path 112.

The plasticizing unit 120 includes, for example, a screw case 122, a drive motor 124, a flat screw 130, a barrel 140, and a heater 150. The plasticizing unit 120 plasticizes at least a part of the material in a solid state supplied from the material supply unit 110, generates a paste-shaped plasticized material having fluidity, and supplies the plasticized material to the nozzle 160.

Plasticizing is a concept including melting and means changing a solid state to a flowable state. Specifically, when glass transition occurs in the material, plasticizing means setting a temperature of the material to a value equal to or higher than a glass transition point. When glass transition does not occur in the material, plasticizing means setting the temperature of the material to a value equal to or higher than a melting point.

The screw case 122 is a housing that houses the flat screw 130. The barrel 140 is provided at a lower surface of the screw case 122. The flat screw 130 is housed in a space surrounded by the screw case 122 and the barrel 140.

The drive motor 124 is provided at an upper surface of the screw case 122. The drive motor 124 is, for example, a servo motor. A shaft 126 of the drive motor 124 is coupled to an upper surface 131 of the flat screw 130. The drive motor 124 is controlled by the control unit 50. Although not shown, the shaft 126 of the drive motor 124 and the upper surface 131 of the flat screw 130 may be coupled to each other via a speed reducer.

The flat screw 130 has a substantially cylindrical shape, a size of which in a rotation axis R direction is smaller than a size of which in a direction orthogonal to the rotation axis R direction. In the shown example, a rotation axis R is parallel to the Z-axis. The flat screw 130 is rotated about the rotation axis R by a torque generated by the drive motor 124.

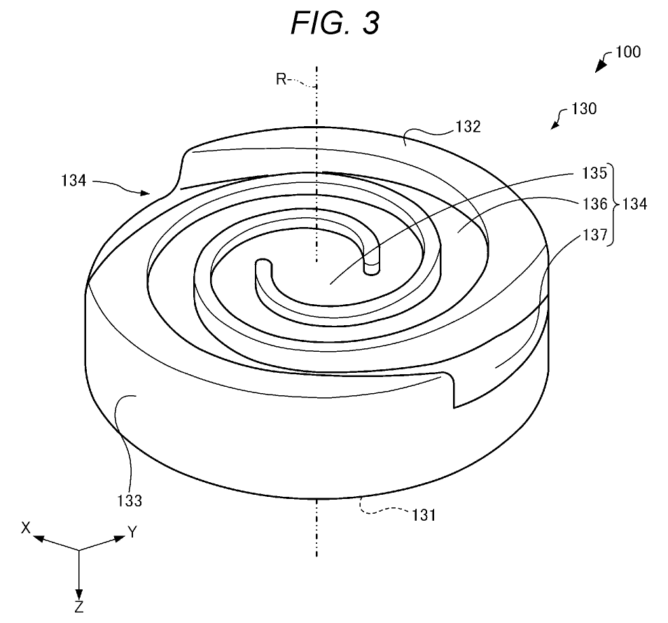

The flat screw 130 includes the upper surface 131, a groove forming surface 132 on the side opposite to the upper surface 131, and a side surface 133 that couples the upper surface 131 and the groove forming surface 132. A first groove 134 is formed on the groove forming surface 132. The side surface 133 is, for example, perpendicular to the groove forming surface 132. Here, FIG. 3 is a perspective view schematically showing the flat screw 130. For convenience, FIG. 3 shows a state where an upper-lower positional relationship is reversed from a state shown in FIG. 2.

As shown in FIG. 3, the first groove 134 is formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the shown example, the coupling portion 136 is provided in a spiral shape from the central portion 135 toward an outer circumference of the groove forming surface 132. The material introduction portion 137 is provided at the outer circumference of the groove forming surface 132. That is, the material introduction portion 137 is provided at the side surface 133 of the flat screw 130. The material supplied from the material supply unit 110 is introduced from the material introduction portion 137 into the first groove 134, passes through the coupling portion 136 and the central portion 135, and is conveyed to the communication hole 146 formed in the barrel 140. For example, two first grooves 134 are provided.

The number of first grooves 134 is not particularly limited. Although not shown, three or more first grooves 134 may be formed or only one first groove 134 may be formed. Although not shown, the plasticizing unit 120 may include, rather than the flat screw 130, an elongated in-line screw including a spiral groove on a side surface thereof. The plasticizing unit 120 may plasticize a material according to rotation of the in-line screw.

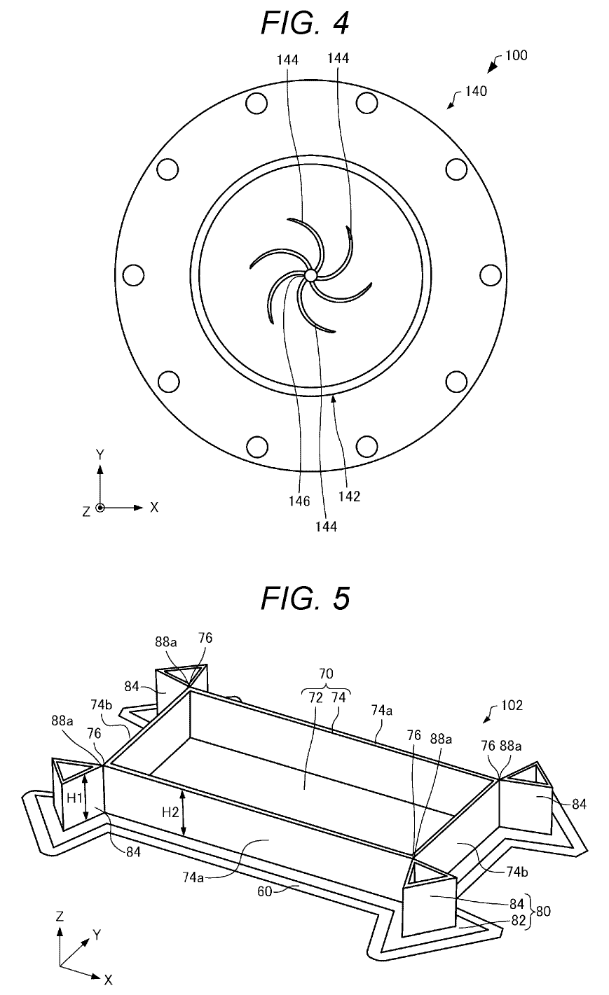

As shown in FIG. 2, the barrel 140 is provided below the flat screw 130. The barrel 140 has a facing surface 142 facing the groove forming surface 132 of the flat screw 130. The communication hole 146 communicating with the first groove 134 is formed in the center of the facing surface 142. Here, FIG. 4 is a plan view schematically showing the barrel 140.

As shown in FIG. 4, a second groove 144 and the communication hole 146 are formed in the facing surface 142 of the barrel 140. A plurality of second grooves 144 are formed. In the shown example, six second grooves 144 are formed. However, the number of second grooves 144 is not particularly limited. The plurality of second grooves 144 are formed around the communication hole 146 when viewed in the Z-axis direction. One end of the second groove 144 is coupled to the communication hole 146 and extends spirally from the communication hole 146 toward an outer circumference of the barrel 140. The second grooves 144 have a function of guiding a plasticized material to the communication hole 146.

Although not shown, a shape of the second groove 144 is not particularly limited, and may be, for example, a linear shape. One end of the second groove 144 may not be coupled to the communication hole 146. Further, the second groove 144 may not be formed on the facing surface 142. However, efficiently guiding a plasticized material to the communication hole 146 is considered, the second groove 144 is preferably formed on the facing surface 142.

As shown in FIG. 2, the heater 150 is provided in the barrel 140. The heater 150 heats the material supplied between the flat screw 130 and the barrel 140. An output of the heater 150 is controlled by the control unit 50. The plasticizing unit 120 heats the material while conveying the material toward the communication hole 146 by the flat screw 130, the barrel 140, and the heater 150 to generate the plasticized material. Then, the plasticizing unit 120 causes the generated plasticized material to flow out from the communication hole 146.

Although not shown, a shape of the heater 150 may be a ring shape when viewed in the Z-axis direction. The heater 150 may be provided below the barrel 140 instead of in the barrel 140.

The nozzle 160 is provided below the barrel 140. A nozzle flow path 162 is formed in the nozzle 160. The nozzle flow path 162 communicates with the communication hole 146. The plasticized material is supplied to the nozzle flow path 162 from the communication hole 146. The nozzle 160 ejects, toward the stage 20, the plasticized material supplied to the nozzle flow path 162 from a tip end 164. The tip end 164 is an end of the nozzle 160 on the stage 20 side. In the shown example, the tip end 164 is an end of the nozzle 160 in a -Z-axis direction.

The valve 170 is provided in the nozzle flow path 162. The valve 170 adjusts an amount of the plasticized material ejected from the nozzle 160. In a state where the valve 170 is closed, the plasticized material is not ejected from the nozzle 160. In a state where the valve 170 is opened, the plasticized material is ejected from the nozzle 160. The valve 170 is, for example, a butterfly valve. The valve 170 is controlled by the control unit 50.

The stage 20 is provided below the nozzle 160. In the shown example, a shape of the stage 20 is a rectangular parallelepiped. The stage 20 includes, for example, a material deposition plate 22 and a heater plate 24. The material deposition plate 22 is provided on the heater plate 24. The material ejected from the ejecting unit 10 is deposited on the material deposition plate 22. A material of the material deposition plate 22 is, for example, a metal such as aluminum. The heater plate 24 is provided between the material deposition plate 22 and the position change unit 30. The heater plate 24 heats the material on the material deposition plate 22. The heater plate 24 includes, for example, a rubber heater. An output of the heater plate 24 is controlled by the control unit 50.

The position change unit 30 supports the stage 20. The position change unit 30 changes the relative positions of the ejecting unit 10 and the stage 20. In the shown example, the position change unit 30 moves the stage 20 in the X-axis direction and the Y-axis direction to thereby change relative positions of the nozzle 160 and the stage 20 in the X-axis direction and the Y-axis direction. Further, the position change unit 30 moves the ejecting unit 10 in the Z-axis direction to thereby change the relative positions of the nozzle 160 and the stage 20 in the Z-axis direction.

The position change unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the ejecting unit 10 in the Z-axis direction. The electric actuators 32, 34, and 36 are controlled by the control unit 50.

A configuration of the position change unit 30 is not particularly limited when the relative positions of the ejecting unit 10 and the stage 20 can be changed. For example, the position change unit 30 may move the stage 20 in the Z-axis direction and move the ejecting unit 10 in the X-axis direction and the Y-axis direction. The position change unit 30 may move the stage 20 or the ejecting unit 10 in the X-axis direction, the Y-axis direction, and the Z-axis direction.

The support unit 40 is coupled to the third electric actuator 36. The support unit 40 supports the ejecting unit 10. The position change unit 30 moves the ejecting unit 10 in the Z-axis direction by moving the support unit 40 in the Z-axis direction by the third electric actuator 36. The ejecting unit 10 is moved in conjunction with the support unit 40.

The heating plate 42 is provided above the stage 20. The heating plate 42 is supported by the support unit 40. Although not shown, the support unit 40 may include a pair of support bowls extending in the Y-axis direction, and the heating plate 42 may be suspended and supported by the pair of support bowls. The heating plate 42 is moved by the position change unit 30 in conjunction with the support unit 40. The heating plate 42 overlaps the stage 20 when viewed in the Z-axis direction. The heating plate 42 includes, for example, a rubber heater. The heating plate 42 heats the shaping layer formed at the stage 20. An output of the heating plate 42 is controlled by the control unit 50.

A through hole 43 is formed in the heating plate 42. The through hole 43 penetrates the heating plate 42 in the Z-axis direction. When the three-dimensional shaped object is shaped, the nozzle 160 of the ejecting unit 10 is positioned in the through hole 43. When the three-dimensional shaped object is shaped, the tip end 164 of the nozzle 160 is positioned below the heating plate 42. In the shown example, two through holes 43 are formed corresponding to two nozzles 160. When the plasticized material is ejected from the first ejecting unit 10a, the tip end 164 of the nozzle 160 of the first ejecting unit 10a is positioned below the heating plate 42, and the tip end 164 of the nozzle 160 of the second ejecting unit 10b is positioned above the heating plate 42. When the plasticized material is ejected from the second ejecting unit 10b, the tip end 164 of the nozzle 160 of the first ejecting unit 10a is positioned above the heating plate 42, and the tip end 164 of the nozzle 160 of the second ejecting unit 10b is positioned below the heating plate 42.

The drive unit 44 is supported by the support unit 40. The drive unit 44 is coupled to, for example, the ejecting unit 10. The drive unit 44 changes relative positions of the nozzle 160 and the heating plate 42. For example, the drive unit 44 moves the ejecting unit 10 in the Z-axis direction to thereby change the relative positions of the nozzle 160 and the heating plate 42 in the Z-axis direction. The drive unit 44 includes, for example, a ball screw, a stepping motor, and a linear guide. The drive unit 44 is moved in conjunction with the support unit 40. For example, two drive units 44 are provided corresponding to the two ejecting units 10. The drive unit 44 is controlled by the control unit 50.

The drive unit 44 may change the relative positions of the nozzle 160 and the heating plate 42 in the Z-axis direction by moving the heating plate 42 in the Z-axis direction without moving the ejecting unit 10. The drive unit 44 may change the relative positions of the nozzle 160 and the heating plate 42 in the Z-axis direction by moving both the ejecting unit 10 and the heating plate 42 in the Z-axis direction.

The control unit 50 is implemented by, for example, a computer including a processor, a main storage device, and an input and output interface for inputting and outputting signals from and to the outside. The control unit 50 exerts various functions by the processor executing programs read into the main storage device. Specifically, the control unit 50 controls the ejecting unit 10, the stage 20, the position change unit 30, the heating plate 42, and the drive unit 44. The control unit 50 may be implemented by a combination of a plurality of circuits instead of a computer.

### 1.2. Three-Dimensional Shaped Object

FIG. 5 is a perspective view schematically showing a three-dimensional shaped object 102 shaped by the three-dimensional shaping device 100.

As shown in FIG. 5, the three-dimensional shaped object 102 includes a release layer 60, a main body portion 70, and a brim layer 80.

The release layer 60 is provided at the stage 20. The release layer 60 is a layer for easily releasing the main body portion 70 and the brim layer 80 from the stage 20. The release layer 60 is a layer separated from the main body portion 70 and the brim layer 80. The release layer is also referred to as a "raft". The release layer 60 may be used as a temporary stage. In a plan view, an area of the release layer 60 is larger than an area of the main body portion 70 and an area of the brim layer 80. A thickness of the release layer 60 is smaller than a thickness of the main body portion 70 and a thickness of the brim layer 80. A material of the release layer 60 is, for example, HIPS. "In a plan view" refers to a case of being viewed in the Z-axis direction in the shown example.

The main body portion 70 is provided at the release layer 60. In the shown example, a shape of the main body portion 70 is a box shape having an opening on the upper side. A material of the main body portion 70 is different from the material of the release layer 60, for example. The material of the main body portion 70 is, for example, ABS resin.

The main body portion 70 includes, for example, a bottom portion 72 and a main body side wall portion 74. The bottom portion 72 forms a bottom surface of the main body portion 70. A shape of the bottom portion 72 is, for example, a rectangle in the plan view.

The main body side wall portion 74 is provided at an outer edge of the bottom portion 72 in the plan view. The main body side wall portion 74 stands upright from the outer edge of the bottom portion 72, for example. In the shown example, four main body side wall portions 74 are provided. In the plan view, two first main body side wall portions 74a among the four main body side wall portions 74 extend in the X-axis direction. Two second main body side wall portions 74b among the four main body side wall portions 74 extend in the Y-axis direction. The first main body side wall portion 74a and the second main body side wall portion 74b are coupled to each other to form a corner portion 76. In the plan view, an outer shell of the main body portion 70 has four corner portions 76. The outer shell of the main body portion 70 is the outermost portion of the main body portion 70. The "corner portion" is a portion that is convex outward, and is not limited to a pointed corner, and includes a curved corner such as a rounded corner.

The brim layer 80 is provided at the release layer 60. A material of the brim layer 80 is, for example, the same as the material of the main body portion 70. The brim layer 80 is a layer separated from the main body portion 70. The brim layer 80 includes, for example, a plate-shaped portion 82 and a triangular prismatic portion 84.

The plate-shaped portion 82 is provided at the release layer 60. The plate-shaped portion 82 surrounds the main body portion 70 in the plan view. In the plan view, an outer edge of the plate-shaped portion 82 is positioned between an outer edge of the release layer 60 and an outer edge of the main body portion 70. The plate-shaped portion 82 is not provided below the main body portion 70.

The triangular prismatic portion 84 is provided on the plate-shaped portion 82. A shape of an outer shell of the triangular prismatic portion 84 is a triangle in the plan view. In the shown example, the shape of the outer shell of the triangular prismatic portion 84 is an equilateral triangle in the plan view. The inside of the triangular prismatic portion 84 is, for example, a cavity. That is, the inside of the triangular prismatic portion 84 is hollow. An opening is formed in an upper surface of the triangular prismatic portion 84. Although not shown, the triangular prismatic portion 84 may be solid with the inside filled.

As shown in FIG. 5, a height H1 of the triangular prismatic portion 84 is, for example, 75% or more and 500% or less of a height H2 of the main body portion 70, and preferably 90% or more and 200% or less of the height H2. In the shown example, the height H1 and the height H2 are the same. The "height" is a distance from the release layer 60, and is a size in the Z-axis direction in the shown example.

In the plan view, an area of one triangular prismatic portion 84 is, for example, 0.003 times or more and 2.0 times or less, preferably 0.01 times or more and 1.5 times or less, more preferably 0.1 times or more and 1.0 times or less, and still more preferably 0.5 times or more and 0.8 times or less the area of the main body portion 70. A volume of one triangular prismatic portion 84 is, for example, 0.003 times or more and 2.0 times or less, preferably 0.01 times or more and 1.5 times or less, more preferably 0.1 times or more and 1.0 times or less, and still more preferably 0.5 times or more and 0.8 times or less a volume of the main body portion 70.

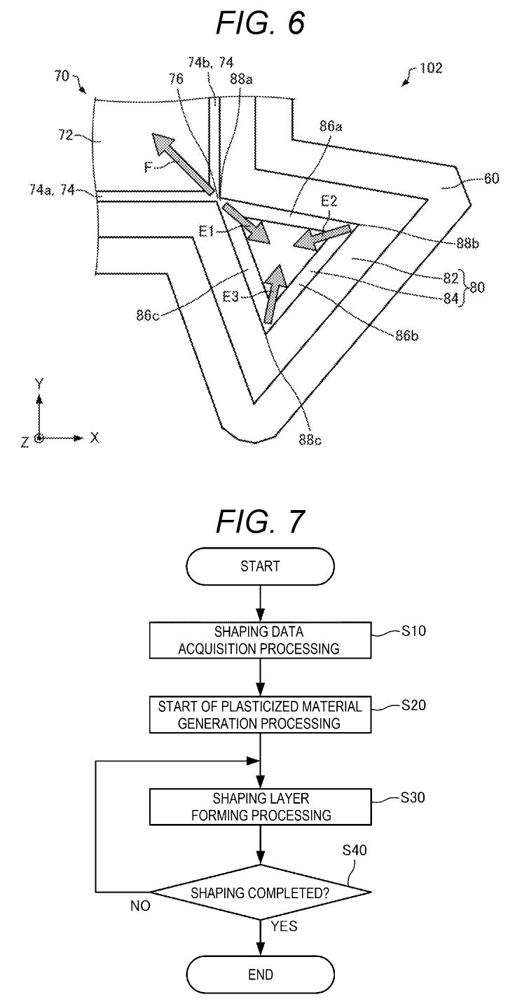

FIG. 6 is a plan view showing the vicinity of the triangular prismatic portion 84 of the three-dimensional shaped object 102.

As shown in FIG. 6, the triangular prismatic portion 84 includes a first brim side wall portion 86a, a second brim side wall portion 86b, and a third brim side wall portion 86c. The triangular prismatic portion 84 is formed by the first brim side wall portion 86a, the second brim side wall portion 86b, and the third brim side wall portion 86c. The brim side wall portions 86a, 86b, and 86c stand upright from the plate-shaped portion 82, for example. The first brim side wall portion 86a and the third brim side wall portion 86c are coupled to each other to form a first corner portion 88a. The first brim side wall portion 86a and the third brim side wall portion 86c are coupled to each other to form a second corner portion 88b. The second brim side wall portion 86b and the third brim side wall portion 86c are coupled to each other to form a third corner portion 88c. The outer shell of the triangular prismatic portion 84 has the first corner portion 88a, the second corner portion 88b, and the third corner portion 88c.

The triangular prismatic portion 84 is in contact with the corner portion 76 of the outer shell of the main body portion 70 in the plan view. For example, four triangular prismatic portions 84 are provided corresponding to the four corner portions 76. The corner portion 76 of the main body portion 70 is in contact with the first corner portion 88a of the triangular prismatic portion 84. The second corner portion 88b and the third corner portion 88c of the triangular prismatic portion 84 are not in contact with the corner portion 76 of the main body portion 70.

Here, at the time of shaping the three-dimensional shaped object 102, due to the heat of the heater plate 24 of the stage 20 and the heating plate 42, a force of contracting in the X-axis direction is generated in the first main body side wall portion 74a, and a force of contracting in the Y-axis direction is generated in the second main body side wall portion 74b. Due to these forces, a warping force that lifts the bottom portion 72 in a +Z-axis direction from the corner portion 76 is generated, and due to the warping force, as shown in FIG. 6, a stress F is generated in the corner portion 76 of the main body portion 70 in the plan view. On the other hand, due to the heat of the heater plate 24 and the heating plate 42, a force of contracting is also generated in the brim side wall portions 86a, 86b, and 86c of the triangular prismatic portion 84, so that stresses E1, E2, and E3 are generated in the corner portions 88a, 88b, and 88c of the triangular prismatic portion 84, respectively, in the plan view. The stress F generated in the corner portion 76 of the main body portion 70 and the stress E1 generated in the first corner portion 88a of the triangular prismatic portion 84 are directed in opposite directions. Therefore, the stress F and the stress E1 can be offset with each other, and the warpage of the bottom portion 72 of the main body portion 70 can be reduced. The brim layer 80 is a layer that prevents the release of the main body portion 70 from the release layer 60 during shaping of the three-dimensional shaped object 102.

### 1.3. Operation

### 1.3.1. Overall Flow

FIG. 7 is a flowchart showing an operation of the three-dimensional shaping device 100. Specifically, FIG. 7 is a flowchart showing processing of the control unit 50 of the three-dimensional shaping device 100.

For example, a user operates an operation unit (not shown) to output, to the control unit 50, a processing start signal for starting processing. The operation unit includes, for example, a mouse, a keyboard, or a touch panel. When receiving the processing start signal, the control unit 50 starts the processing.

First, as shown in FIG. 7, in step S10, the control unit 50 performs shaping data acquisition processing of acquiring shaping data for shaping a three-dimensional shaped object.

The shaping data includes information concerning, for example, a type of a material stored in the material supply unit 110, a movement path of the ejecting unit 10 with respect to the stage 20, and an amount of a plasticized material ejected from the ejecting unit 10.

The shaping data is created by, for example, causing slicer software installed in a computer coupled to the three-dimensional shaping device 100 to read shape data. The shape data is data representing a target shape of a three-dimensional shaped object created using three-dimensional computer aided design (CAD) software, three-dimensional computer graphics (CG) software, or the like. As the shape data, for example, data such as data in a standard triangulated language (STL) format or an additive manufacturing file format (AMF) is used. The slicer software divides the target shape of the three-dimensional shaped object into layers having predetermined thicknesses and creates the shaping data for each of the layers. The shaping data is represented by a G code, an M code, or the like. The control unit 50 acquires the shaping data from a computer coupled to the three-dimensional shaping device 100 or a recording medium such as a universal serial bus (USB) memory.

Next, in step S20, the control unit 50 starts plasticized material generation processing of plasticizing a material to generate a plasticized material. Specifically, the control unit 50 drives the drive motor 124 and the heater 150 to plasticize the material supplied from the material supply unit 110 to the plasticizing unit 120 and generate the plasticized material. The control unit 50 continues to generate the plasticized material until shaping layer forming processing is completed.

Next, in step S30, the control unit 50 performs the shaping layer forming processing of forming a shaping layer by ejecting the plasticized material from the nozzle 160 toward the stage 20 while moving the ejecting unit 10 relative to the stage 20.

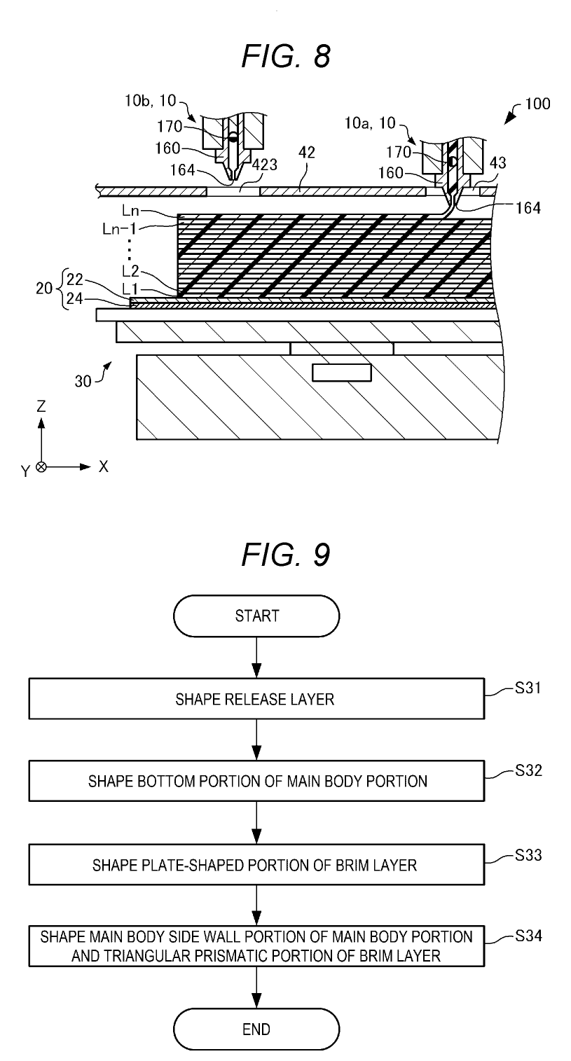

Here, FIG. 8 is a cross-sectional view showing the shaping layer forming processing by the control unit 50 of the three-dimensional shaping device 100.

As shown in FIG. 8, based on the acquired shaping data, while controlling the position change unit 30 to change the relative positions of the ejecting unit 10 and the stage 20, the control unit 50 controls the ejecting unit 10 to eject the plasticized material from the nozzle 160 toward the stage 20.

Specifically, before the shaping layer forming processing is started, that is, before formation of a shaping layer L1 which is a first shaping layer is started, the nozzle 160 is disposed at an initial position in a -X-axis direction of an end portion of the stage 20 in the -X-axis direction. When the shaping layer forming processing is started, as shown in FIG. 6, the control unit 50 controls the position change unit 30 to, for example, move the nozzle 160 in a +X-axis direction relative to the stage 20. When the nozzle 160 passes over the stage 20, the plasticized material is ejected from the nozzle 160. Accordingly, the shaping layer L1 is formed. In FIG. 8, shaping layers up to an n-th shaping layer Ln are shown, where n is any natural number. In the shaping layer forming processing, the heater plate 24 of the stage 20 and the heating plate 42 are driven.

In the shown example, the plasticized material is ejected from the first ejecting unit 10a to form the shaping layer. The tip end 164 of the nozzle 160 of the first ejecting unit 10a is positioned below the heating plate 42. The tip end 164 of the nozzle 160 of the second ejecting unit 10b is positioned above the heating plate 42. The valve 170 of the first ejecting unit 10a is opened. The valve 170 of the second ejecting unit 10b is closed.

Next, as shown in FIG. 7, in step S40, the control unit 50 performs determination processing of determining, based on the shaping data, whether the formation of all the shaping layers is completed.

When it is determined that the formation of all the shaping layers is not completed ("NO" in step S40), the control unit 50 returns the processing to step S30. The control unit 50 repeats step S30 and step S40 until it is determined that the formation of all the shaping layers is completed in step S40.

On the other hand, when it is determined that the formation of all the shaping layers is completed ("YES" in step S40), the control unit 50 ends the processing.

### 1.3.2. Details of Shaping Layer Forming Processing

FIG. 9 is a flowchart showing the shaping layer forming processing by the control unit 50 of the three-dimensional shaping device 100.

After starting the plasticized material generation processing, as shown in FIG. 9, in step S31, the control unit 50 performs processing of shaping the release layer 60 at the stage 20 by ejecting the plasticized material. Specifically, the control unit 50 controls the second ejecting unit 10b and the position change unit 30 to eject the plasticized HIPS from the second ejecting unit 10b and shape the release layer 60 at the stage 20. The number of shaping layers forming the release layer 60 is, for example, 1 or more and 10 or less, and can be freely designated by the user. The data for shaping the release layer 60 may be included in the shaping data or may be generated by the control unit 50 analyzing the shaping data for shaping the main body portion 70.

Next, in step S32, the control unit 50 performs processing of shaping the bottom portion 72 of the main body portion 70 by ejecting the plasticized material. Specifically, the control unit 50 controls, based on the shaping data, the first ejecting unit 10a and the position change unit 30 to eject the plasticized ABS resin from the first ejecting unit 10a and shape the bottom portion 72 at the release layer 60.

Next, in step S33, the control unit 50 performs processing of ejecting the plasticized material and shaping the plate-shaped portion 82 of the brim layer 80 at the release layer 60. Specifically, the control unit 50 controls the first ejecting unit 10a and the position change unit 30 to eject the plasticized ABS resin from the first ejecting unit 10a and shape the plate-shaped portion 82 at the release layer 60. The number of shaping layers forming the plate-shaped portion 82 is, for example, 1 or more and 10 or less, and can be freely designated by the user. The data for shaping the plate-shaped portion 82 may be included in the shaping data or may be generated by the control unit 50 analyzing the shaping data for shaping the main body portion 70.

The order of the processing of step S32 and the processing of step S33 is not particularly limited, and the processing of step S33 may be performed before the processing of step S32. That is, the plate-shaped portion 82 of the brim layer 80 may be shaped before shaping the bottom portion 72 of the main body portion 70.

Next, in step S34, the control unit 50 performs processing of ejecting the plasticized material, stacking the shaping layers, and shaping the main body side wall portion 74 of the main body portion 70 and the triangular prismatic portion 84 of the brim layer 80. Specifically, the control unit 50 controls, based on the shaping data, the first ejecting unit 10a and the position change unit 30 to eject the plasticized ABS resin from the first ejecting unit 10a and shape the main body side wall portion 74 and the triangular prismatic portion 84. Accordingly, the main body portion 70 and the brim layer 80 are shaped.

The control unit 50 ends the shaping layer forming processing.

Thereafter, the user performs a step of releasing the main body portion 70 and the brim layer 80 from the release layer 60 and separating the main body portion 70 and the brim layer 80. This step is performed manually or by a cutting device. Accordingly, the main body portion 70 can be obtained.

In a method for manufacturing the three-dimensional shaped object according to the embodiment, for example, the three-dimensional shaped object 102 can be manufactured using the three-dimensional shaping device 100.

### 1.4. Functions and Effects

The method for manufacturing the three-dimensional shaped object 102 includes: ejecting HIPS as a first material to shape the release layer 60 at the stage 20; ejecting an ABS resin as a second material to stack the shaping layer at the release layer 60 and shape the main body portion 70 of the three-dimensional shaped object 102; and ejecting an ABS resin as a third material to shape the brim layer 80 at the release layer 60. The release layer 60 and the brim layer 80 are layers separated from the main body portion 70, and the brim layer 80 has the triangular prismatic portion 84 in contact with the corner portion 76 of the outer shell of the main body portion 70 in the plan view. Therefore, in the method for manufacturing the three-dimensional shaped object 102, as described above, the warpage of the main body portion 70 can be reduced by the brim layer 80.

In the method for manufacturing the three-dimensional shaped object 102, the corner portion 76 of the main body portion 70 and the first corner portion 88a of the triangular prismatic portion 84 are in contact with each other. Therefore, in the method for manufacturing the three-dimensional shaped object 102, the triangular prismatic portion 84 can reduce the warpage of the main body portion 70.

In the method for manufacturing the three-dimensional shaped object 102, the stress F generated in the corner portion 76 of the main body portion 70 and the stress E1 generated in the first corner portion 88a of the triangular prismatic portion 84 are directed in opposite directions in the plan view. Therefore, in the method for manufacturing the three-dimensional shaped object 102, the stress F and the stress E1 can be offset with each other, and the warpage of the main body portion 70 can be prevented.

In the method for manufacturing the three-dimensional shaped object 102, the inside of the triangular prismatic portion 84 is hollow. Therefore, in the method for manufacturing the three-dimensional shaped object 102, the warpage of the main body portion 70 can be further reduced.

The inside of the triangular prismatic portion 84 may be solid. Since the solid portion has a volume larger than the hollow portion, the solid portion has a heat storage effect. The warpage is likely to occur during rapid cooling. Therefore, when the inside of the triangular prismatic portion 84 is solid, heat is easily transferred to and from the main body portion 70, and a temperature change of the main body portion 70 can be slowed down.

In the method for manufacturing the three-dimensional shaped object 102, the height H1 of the triangular prismatic portion 84 is 75% or more of the height H2 of the main body portion 70. Therefore, in the method for manufacturing the three-dimensional shaped object 102, the warpage of the main body portion 70 can be reduced as compared with a case where the height H1 is less than 75% of the height H2.

In the method for manufacturing the three-dimensional shaped object 102, the second material and the third material are the same material. Therefore, in the method for manufacturing the three-dimensional shaped object 102, thermal expansion coefficients of the main body portion 70 and the triangular prismatic portion 84 can be made the same, and the possibility that the contact between the main body portion 70 and the triangular prismatic portion 84 is unintentionally released due to the temperature change can be reduced.

Although an example in which the first material is different from the second material and the third material has been described above, the first material, the second material, and the third material may be the same material. In this case, only one ejecting unit 10 may be provided.

### 2. Modifications of Three-Dimensional Shaped Object

### 2.1. First Modification

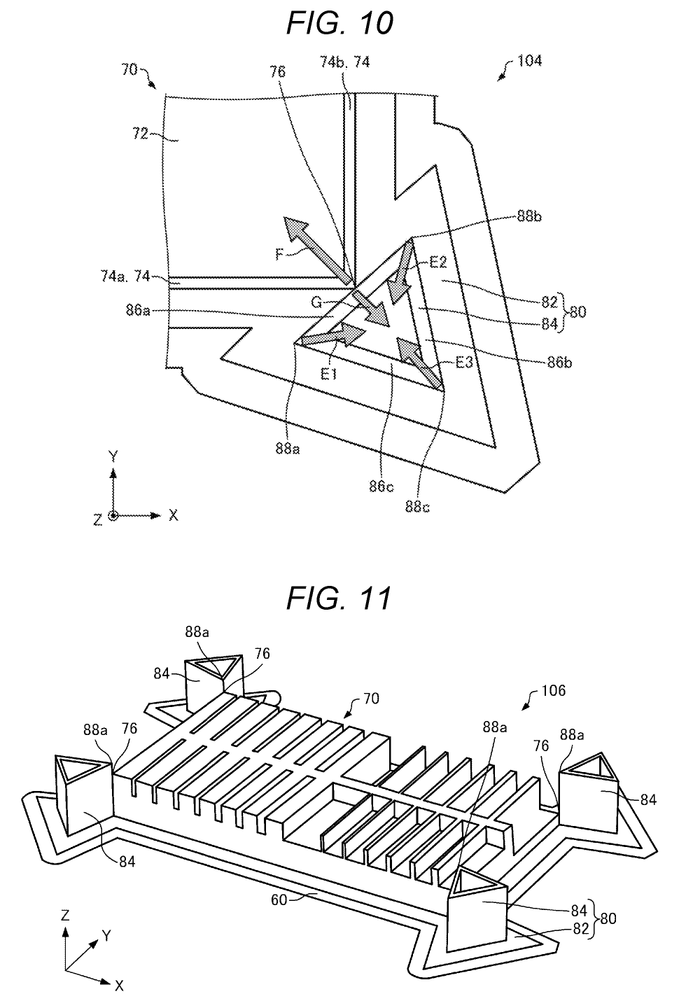

Next, a three-dimensional shaped object according to a first modification of the embodiment will be described with reference to the drawings. FIG. 10 is a plan view schematically showing a three-dimensional shaped object 104 according to the first modification of the embodiment.

Hereinafter, in the three-dimensional shaped object 104 according to the first modification of the embodiment, points different from the example of the three-dimensional shaped object 102 according to the embodiment described above will be described, and description of the same points will be simplified or omitted. This is the same in a three-dimensional shaped object according to second and third modifications of the embodiment described later.

In the three-dimensional shaped object 102 described above, as shown in FIG. 6, the corner portion 76 of the main body portion 70 and the first corner portion 88a of the triangular prismatic portion 84 are in contact with each other.

On the other hand, in the three-dimensional shaped object 104, as shown in FIG. 10, the corner portion 76 of the main body portion 70 and the first brim side wall portion 86a of the triangular prismatic portion 84 are in contact with each other. The corner portion 76 is in contact with an outer shell of the first brim side wall portion 86a. The corner portion 76 is in contact with, for example, a center of the outer shell of the first brim side wall portion 86a. The corner portions 88a, 88b, and 88c of the triangular prismatic portion 84 are not in contact with the corner portion 76 of the main body portion 70. In a plan view, the stress F generated in the corner portion 76 and a stress G generated in the first brim side wall portion 86a are directed in opposite directions. The stress G is a resultant force of the stress E1 generated in the first corner portion 88a and the stress E2 generated in the second corner portion 88b.

In a method for manufacturing the three-dimensional shaped object 104, the corner portion 76 of the main body portion 70 and the first brim side wall portion 86a of the triangular prismatic portion 84 are in contact with each other. Therefore, in the method for manufacturing the three-dimensional shaped object 104, the triangular prismatic portion 84 can reduce the warpage of the main body portion 70.

In the method for manufacturing the three-dimensional shaped object 104, in the plan view, the stress F generated in the corner portion 76 of the main body portion 70 and the stress G generated in the first brim side wall portion 86a of the triangular prismatic portion 84 are directed in opposite directions. Therefore, in the method for manufacturing the three-dimensional shaped object 104, the stress F and the stress G can be offset with each other, and the warpage of the main body portion 70 can be prevented.

### 2.2. Second Modification

Next, the three-dimensional shaped object according to the second modification of the embodiment will be described with reference to the drawings. FIG. 11 is a perspective view schematically showing a three-dimensional shaped object 106 according to the second modification of the embodiment.

In the three-dimensional shaped object 102 described above, as shown in FIG. 5, the main body portion 70 has a box shape having an opening on the upper side.

In contrast, in the three-dimensional shaped object 106, as shown in FIG. 11, the shape of the main body portion 70 is not a box shape. The inside of the main body portion 70 may be filled. The shape of the main body portion 70 is not limited to the example shown in FIG. 5 or the example shown in FIG. 11.

### 2.3. Third Modification

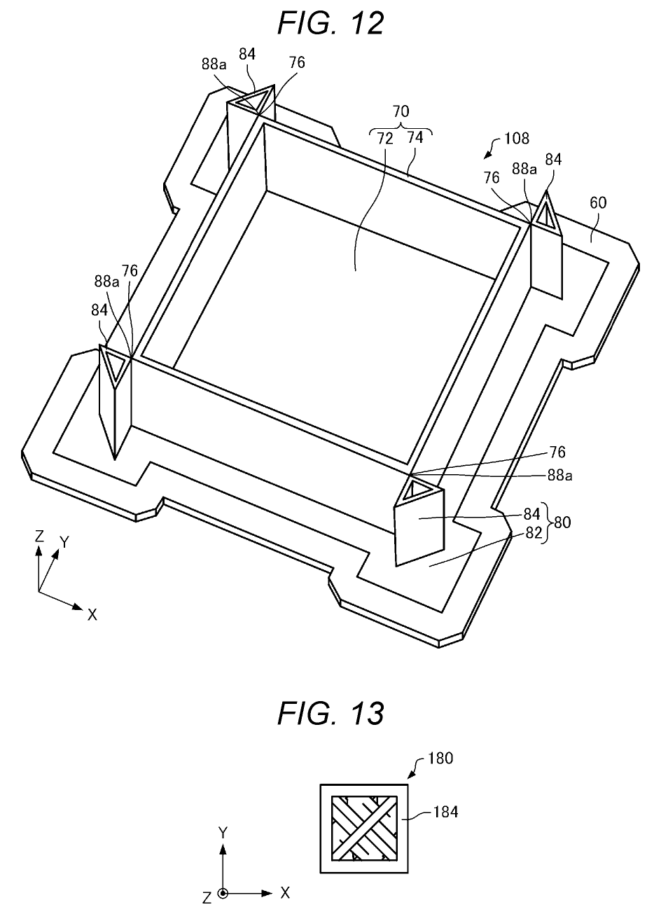

Next, the three-dimensional shaped object according to the third modification of the embodiment will be described with reference to the drawings. FIG. 12 is a perspective view schematically showing a three-dimensional shaped object 108 according to the third modification of the embodiment.

In the three-dimensional shaped object 102 described above, as shown in FIG. 5, the shape of the outer shell of the triangular prismatic portion 84 is an equilateral triangle in the plan view.

In contrast, in the three-dimensional shaped object 108, as shown in FIG. 12, the shape of the outer shell of the triangular prismatic portion 84 is an isosceles right triangle in a plan view. In the shown example, an angle of the first corner portion 88a in contact with the corner portion 76 of the main body portion 70 is 90°.

As a three-dimensional shaped object according to a reference example, as shown in FIG. 13, for example, a brim layer 180 has a quadrangular prismatic portion 184. The inside of the quadrangular prismatic portion 184 is filled. The quadrangular prismatic portion 184 has, for example, a truss structure.

### 3. Modification of Material

Next, modifications of the material used in the three-dimensional shaping device 100 according to the embodiment will be described.

In the three-dimensional shaping device 100 described above, the material ejected from the first ejecting unit 10a is the ABS resin, and the material ejected from the second ejecting unit 10b is the HIPS, but the materials ejected from the ejecting units 10a and 10b are not limited thereto.

Examples of the material ejected from the ejecting units 10a and 10b include various materials such as a thermoplastic material, a metal material, and a ceramic material as main materials. Here, the "main material" means a material mainly forming the shape of the three-dimensional shaped object manufactured by the three-dimensional shaping device 100, and means a material that accounts for a content of 50 mass% or more in the three-dimensional shaped object. The material described above includes a material obtained by melting the main material alone and a material obtained by melting a part of components contained together with the main materials into a paste form.

Examples of the thermoplastic material include a thermoplastic resin. Examples of the thermoplastic resin include general-purpose plastic, general-purpose engineering plastic, and super engineering plastic.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

Pigment, metal, and ceramic and, besides, additives such as a wax, a flame retardant, an antioxidant, and a heat stabilizer may be mixed into the thermoplastic material. In the plasticizing unit 120, the thermoplastic material is plasticized and converted into a molten state by rotation of the flat screw 130 and heating of the heater 150. The plasticized material generated as described above is ejected from the nozzle 160 and deposited on the stage 20, and is thereafter cured according to a temperature drop.

In the plasticizing unit 120, for example, a metal material may be used as the main material instead of the thermoplastic material described above. In this case, it is desirable that a powder material obtained by powdering the metal material is mixed with a component that melts when the plasticized material is generated and the mixture is fed into the plasticizing unit 120.

Examples of the metal material include single metal such as magnesium (Mg), iron (Fe), cobalt (Co), chromium (Cr), aluminum (Al), titanium (Ti), copper (Cu), and nickel (Ni) or an alloy containing one or more of these types of metal, maraging steel, stainless steel, cobalt chromium molybdenum, a titanium alloy, a nickel alloy, an aluminum alloy, a cobalt alloy, and a cobalt chromium alloy.

In the plasticizing unit 120, a ceramic material can be used as the main material instead of the metal material described above. Examples of the ceramic material include oxide ceramic such as silicon dioxide, titanium dioxide, aluminum oxide, and zirconium oxide, and non-oxide ceramic such as aluminum nitride.

A powder material of the metal material or the ceramic material ejected from the ejecting units 10a and 10b may be a mixed material obtained by mixing a plurality of types of powder of the single metal, powder of the alloy, or powder of the ceramic material. The powder material of the metal material or the ceramic material may be coated with, for example, the thermoplastic resin described above or thermoplastic resin other than the thermoplastic resin. In this case, in the plasticizing unit 120, the thermoplastic resin may melt to exhibit fluidity.

For example, a solvent may be added to the powder material of the metal material or the ceramic material ejected from the ejecting units 10a and 10b. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

In addition, for example, a binder may be added to the powder material of the metal material or the ceramic material ejected from the ejecting units 10a and 10b. Examples of the binder include acrylic resin, epoxy resin, silicone resin, and cellulose-based resin, other synthetic resin, PLA, PA, PPS, and PEEK, and other thermoplastic resin.

### 4. Experimental Example

### 4.1. Preparation of Sample

### Sample 1

A three-dimensional shaped object was manufactured using a three-dimensional shaping device corresponding to the three-dimensional shaping device 100 described above. A temperature of a heater of an ejecting unit was set to 220°C. A temperature of a heater plate of a stage was set to 95°C. A temperature of a heating plate was set to 65°C. HIPS was used as a material from one of two ejecting units, and a release layer made of HIPS was shaped. A material ejected from the other ejecting unit of the two ejecting units was an ABS resin, and a main body portion and a brim layer made of the ABS resin were shaped.

FIG. 14 is a perspective view schematically showing Sample 1 used in the experimental example. As shown in FIG. 14, a shape of the main body portion was a box shape having an opening on the upper side. A bottom surface of the main body portion had a size of 50 mm × 50 mm. A height of the main body portion and a height of a columnar structure portion of the brim layer were 20 mm. A plate-shaped portion of the brim layer was not shaped. In Sample 1, the columnar structure portion of the brim layer was a hollow triangular prismatic portion. In a plan view, a length of a side wall portion of the columnar structure portion was 20 mm.

### Sample 2

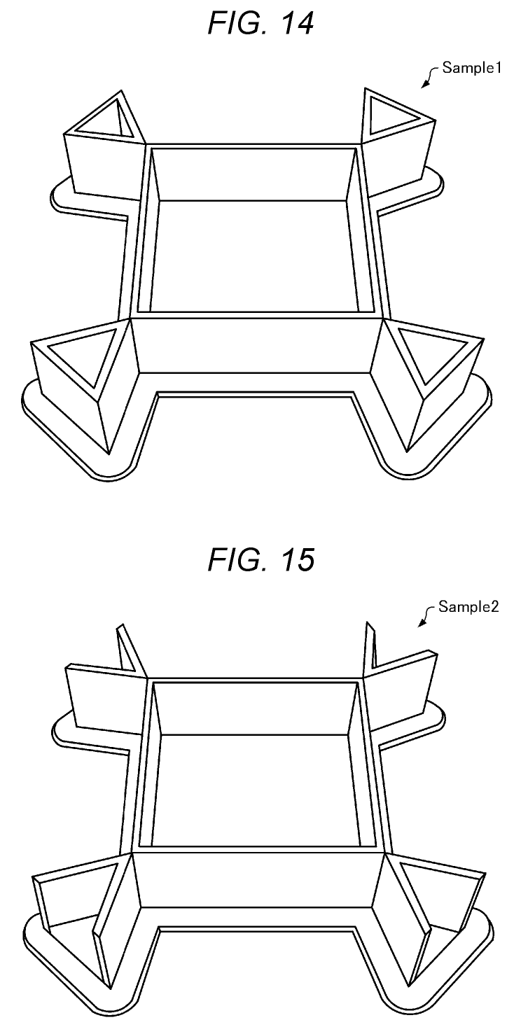

FIG. 15 is a perspective view schematically showing Sample 2 used in the experimental example. As shown in FIG. 15, Sample 2 was produced in the same manner as Sample 1 except that the columnar structure portion of the brim layer had a shape in which one side wall portion of the hollow triangular prismatic portion was removed.

### Sample 3

FIG. 16 is a perspective view schematically showing Sample 3 used in the experimental example. As shown in FIG. 16, Sample 3 was produced in the same manner as Sample 1 except that the columnar structure portion of the brim layer was a hollow quadrangular prismatic portion. In a plan view, a length of a side wall portion of the columnar structure portion was 20 mm.

### Sample 4

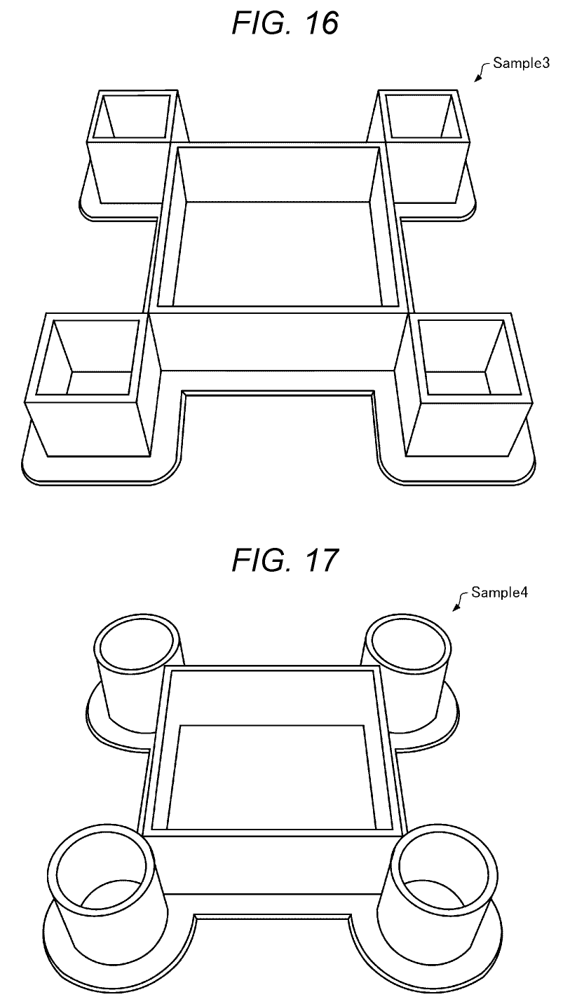

FIG. 17 is a perspective view schematically showing Sample 4 used in the experimental example. As shown in FIG. 17, Sample 4 was produced in the same manner as Sample 1 except that the columnar structure portion of the brim layer was a hollow cylindrical portion. A diameter of the cylindrical portion was 20 mm.

### Sample 5

FIG. 18 is a perspective view schematically showing Sample 5 used in the experimental example. As shown in FIG. 18, Sample 5 was produced in the same manner as Sample 1 except that the columnar structure portion of the brim layer was a hollow hexagonal prismatic portion. A diameter of a minimum inclusion circle circumscribing an outer shell of the hexagonal prismatic portion in a plan view was 20 mm.

### Sample 6

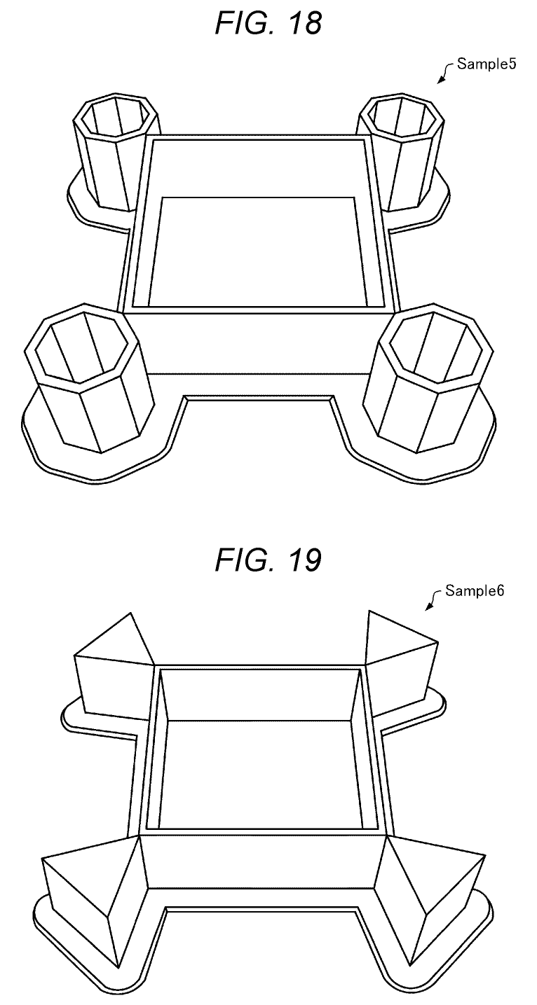

FIG. 19 is a perspective view schematically showing Sample 6 used in the experimental example. As shown in FIG. 19, Sample 6 was produced in the same manner as Sample 1 except that the columnar structure portion of the brim layer was a solid triangular prismatic portion.

### Sample 7

FIG. 20 is a perspective view schematically showing Sample 7 used in the experimental example. As shown in FIG. 20, Sample 7 was produced in the same manner as Sample 6 except that a length of a side wall portion of the triangular prismatic portion of the brim layer was 5 mm.

### Sample 8

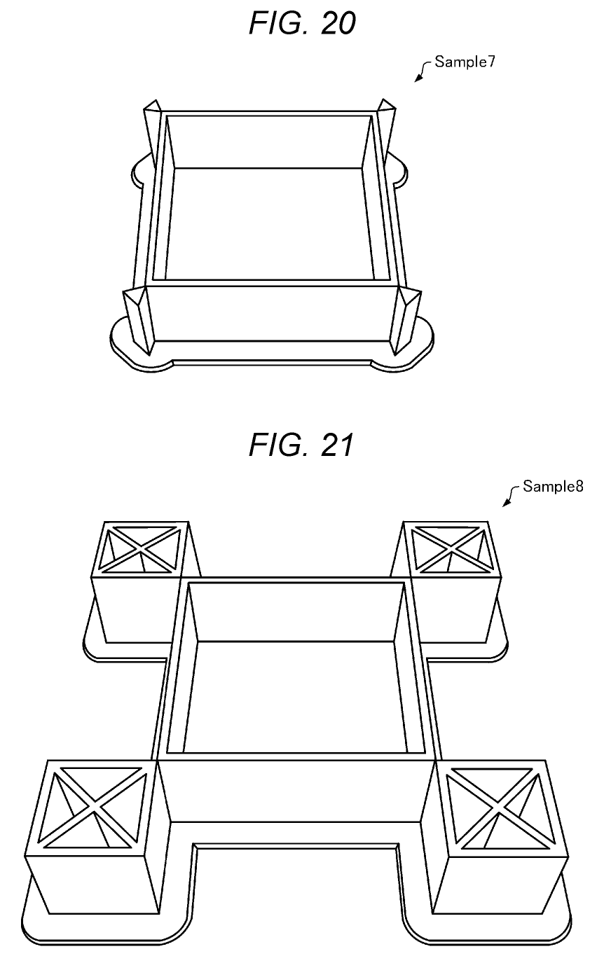

FIG. 21 is a perspective view schematically showing Sample 8 used in the experimental example. As shown in FIG. 21, Sample 8 was produced in the same manner as Sample 3 except that hollow triangular prismatic portions were shaped inside the columnar structure portion of the brim layer.

### Sample 9

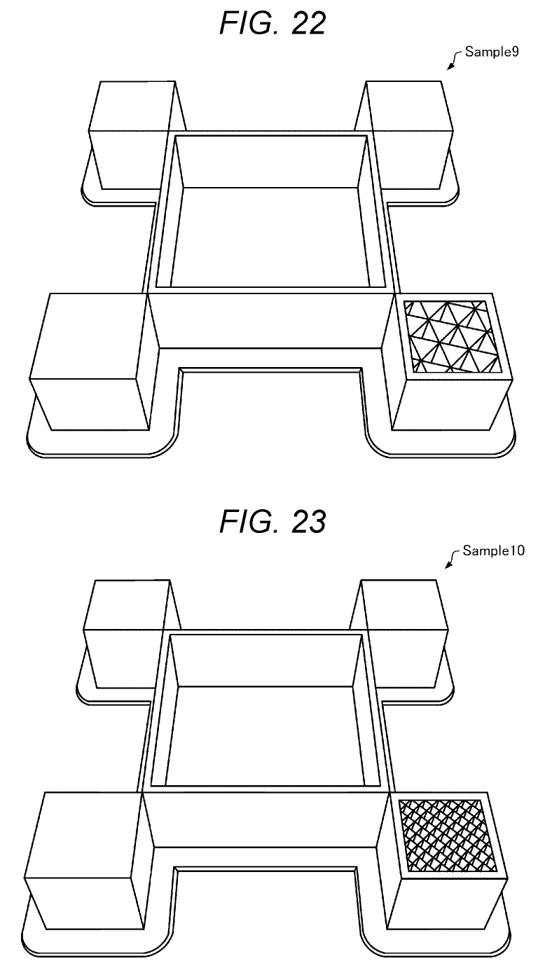

FIG. 22 is a perspective view schematically showing Sample 9 used in the experimental example. As shown in FIG. 22, Sample 9 was produced in the same manner as Sample 8 except that the columnar structure portion of the brim layer was made solid by shaping triangular prismatic portions inside. A filling rate inside the columnar structure portion was 20%.

For convenience, in FIG. 22, one of the columnar structure portions of the brim layer is indicated by a path (a path of a nozzle of the ejecting unit) when the inside of the columnar structure portion is filled. This holds true for FIG. 23, which will be described later.

### Sample 10

FIG. 23 is a perspective view schematically showing Sample 10 used in the experimental example. As shown in FIG. 23, Sample 10 was produced in the same manner as Sample 9 except that a path when the inside of the columnar structure portion of the brim layer was filled was changed. A filling rate inside the columnar structure portion was 20%.

### Sample 11

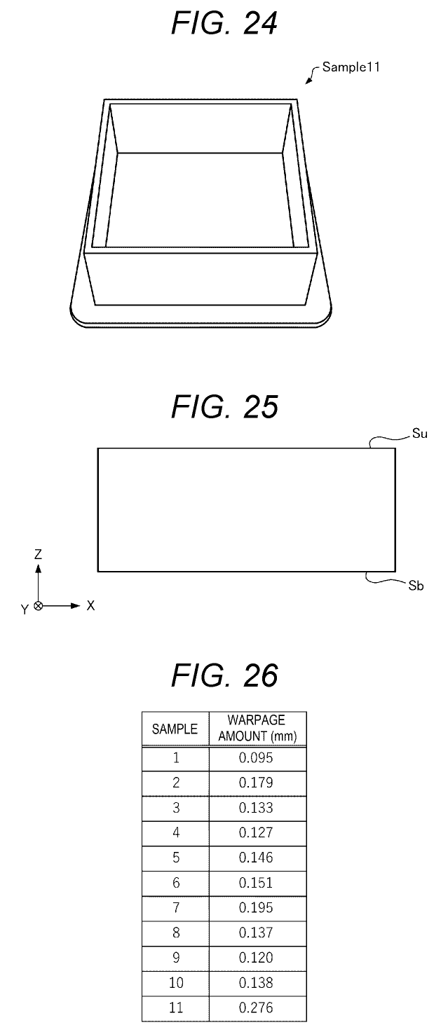

FIG. 24 is a perspective view schematically showing Sample 11 used in the experimental example. As shown in FIG. 24, Sample 11 was produced in the same manner as Sample 1 except that the brim layer was not shaped.

### 4.2. Evaluation Method

Warpage of a bottom portion of the main body portion of each of Sample 1 to Sample 11 described above was measured using a surface shape measurement system "TMS" manufactured by Polytech Japan Ltd. Specifically, as shown in FIG. 25, an upper surface Su of the side wall portion of the main body portion was parallel, and a difference between a maximum distance and a minimum distance, between a bottom surface Sb of the main body portion and the upper surface Su of the side wall portion of the main body portion, was defined as a warpage amount. The warpage was evaluated by an average value of the warpage amounts in the X-axis direction and the Y-axis direction. FIG. 25 is a side view of the main body portion showing an evaluation method for the warpage in the experimental example.

### 4.3. Evaluation Result

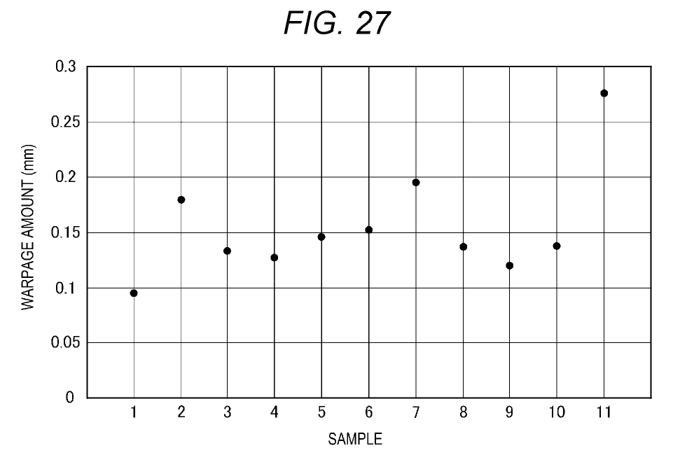

FIG. 26 is a table showing an evaluation result of the experimental example. FIG. 27 is a graph showing the evaluation result of the experimental example, in which values of the table of FIG. 26 are plotted. As shown in FIGS. 26 and 27, Samples 1 to 10 each had a warpage amount smaller than Sample 11. Accordingly, it was found that the columnar structure portion of the brim layer could reduce the warpage of the main body portion.

Sample 1 had a warpage amount smaller than Samples 2 to 5 and 8 to 10. Accordingly, it was found that when the columnar structure portion of the brim layer had a triangular prismatic portion, the warpage of the main body portion could be reduced as compared with a case where the columnar structure portion had another shape.

Sample 1 had a warpage amount smaller than Sample 6. Accordingly, it was found that when the inside of the triangular prismatic portion of the brim layer is hollow, the warpage of the main body portion could be reduced as compared with a case where the inside of the triangular prismatic portion is solid.

Sample 6 had a warpage amount smaller than Sample 7. Accordingly, it was found that the larger the triangular prismatic portion of the brim layer, the smaller the warpage of the main body portion.

The embodiment and modifications described above are merely examples, and the present disclosure is not limited thereto. For example, the embodiment and the modifications can be combined with each other as appropriate.

The present disclosure includes a configuration that is substantially the same as the configuration described in the embodiment, such as a configuration having the same function, using the method, and providing the same result, or a configuration having the same object and providing the same advantages. The present disclosure further includes a configuration in which a non-essential portion of the configuration described in the embodiment is replaced with another portion. The present disclosure further includes a configuration providing effects and advantages that are the same as those provided by the configuration described in the embodiment, or a configuration that can achieve the same object. The present disclosure further includes the configuration described in the embodiment to which a known technology is added.

The following contents can be derived from the embodiment and modifications described above.

An aspect of a method for manufacturing a three-dimensional shaped object includes:

ejecting a first material to shape a release layer at a stage;

ejecting a second material to stack a shaping layer at the release layer and shape a main body portion of the three-dimensional shaped object; and

ejecting a third material to shape a brim layer at the release layer, in which

the release layer and the brim layer are layers separated from the main body portion, and

the brim layer has a triangular prismatic portion in contact with a corner portion of an outer shell of the main body portion in a plan view.

According to the method for manufacturing the three-dimensional shaped object, warpage of the main body portion can be reduced by the brim layer.

In the aspect of the method for manufacturing a three-dimensional shaped object,

the corner portion of the main body portion and a corner portion of the triangular prismatic portion may be in contact with each other.

According to the method for manufacturing the three-dimensional shaped object, the warpage of the main body portion can be reduced by the triangular prismatic portion.

In the aspect of the method for manufacturing a three-dimensional shaped object,

the corner portion of the main body portion and a side wall portion of the triangular prismatic portion may be in contact with each other.

According to the method for manufacturing the three-dimensional shaped object, the warpage of the main body portion can be reduced by the triangular prismatic portion.

In the aspect of the method for manufacturing a three-dimensional shaped object,

in the plan view, a stress generated in the corner portion of the main body portion and a stress generated in the corner portion of the triangular prismatic portion may be directed in opposite directions.

According to the method for manufacturing the three-dimensional shaped object, the stress generated in the corner portion of the main body portion and the stress generated in the corner portion of the triangular prismatic portion can be offset with each other, and the warpage of the main body portion can be prevented.

In the aspect of the method for manufacturing a three-dimensional shaped object,

in the plan view, a stress generated in the corner portion of the main body portion and a stress generated in the side wall portion of the triangular prismatic portion may be directed in opposite directions.

According to the method for manufacturing the three-dimensional shaped object, the stress generated in the corner portion of the main body portion and the stress generated in the side wall portion of the triangular prismatic portion can be offset with each other, and the warpage of the main body portion can be prevented.

In the aspect of the method for manufacturing a three-dimensional shaped object,

an inside of the triangular prismatic portion may be hollow.

According to the method for manufacturing the three-dimensional shaped object, the warpage of the main body portion can be further reduced.

In the aspect of the method for manufacturing a three-dimensional shaped object,

a height of the triangular prismatic portion may be 75% or more of a height of the main body portion.

According to the method for manufacturing the three-dimensional shaped object, the warpage of the main body portion can be reduced.

In the aspect of the method for manufacturing a three-dimensional shaped object,

the second material and the third material may be a same material.

According to the method for manufacturing the three-dimensional shaped object, it is possible to reduce the possibility that the contact between the main body portion and the triangular prismatic portion is unintentionally released due to a temperature change.

What is claimed is:

1. A method for manufacturing a three-dimensional shaped object, the method comprising:
ejecting a first material to shape a release layer at a stage;
ejecting a second material to stack a shaping layer at the release layer and shape a main body portion of the three-dimensional shaped object; and
ejecting a third material to shape a brim layer at the release layer, wherein
the release layer and the brim layer are layers separated from the main body portion, and
the brim layer has a triangular prismatic portion in contact with a corner portion of an outer shell of the main body portion in a plan view.

2. The method for manufacturing a three-dimensional shaped object according to claim 1, wherein
the corner portion of the main body portion and a corner portion of the triangular prismatic portion are in contact with each other.

3. The method for manufacturing a three-dimensional shaped object according to claim 1, wherein
the corner portion of the main body portion and a side wall portion of the triangular prismatic portion are in contact with each other.

4. The method for manufacturing a three-dimensional shaped object according to claim 2, wherein
in the plan view, a stress generated in the corner portion of the main body portion and a stress generated in the corner portion of the triangular prismatic portion are directed in opposite directions.

5. The method for manufacturing a three-dimensional shaped object according to claim 3, wherein
in the plan view, a stress generated in the corner portion of the main body portion and a stress generated in the side wall portion of the triangular prismatic portion are directed in opposite directions.

6. The method for manufacturing a three-dimensional shaped object according to claim 1, wherein
an inside of the triangular prismatic portion is hollow.

7. The method for manufacturing a three-dimensional shaped object according to claim 1, wherein
a height of the triangular prismatic portion is 75% or more of a height of the main body portion.

8. The method for manufacturing a three-dimensional shaped object according to claim 1, wherein
the second material and the third material are a same material.
